(19) United States
(12) Patent Application Publication
(10) Pub. No.: US 2005/0268006 A1
(43) Pub. Date: Dec. 1, 2005

(54) Digital interface supporting internal and external USB transceivers

(75) Inventors: Joseph Julicher, Chandler, AZ (US); Igor Wojewoda, Tempe, AZ (US); Mei-Ling Chen, Chandler, AZ (US)

Correspondence Address: Baker Botts L.L.P.;One Shell Plaza, 210 Louisiana Street, Houston, TX, 77002-4995, US

(73) Assignee: Microchip Technology Incorporated

(21) Appl. No.: 11/040,397

(22) Filed: Jan. 21, 2005

Related U.S. Application Data
(60) Provisional application No. 60/574,560, filed on May 26, 2004.

(51) Int. Cl. G06F 13/12

(52) U.S. Cl. 710/62

(57) ABSTRACT

A digital device has a USB interface module that supports selection between an internal USB transceiver of the digital device and an external USB transceiver. Selection of either the internal or external USB transceiver may be controlled with a bit in a control register or memory location. The external USB transceiver may be electrically isolated from the USB interface module and/or extended over longer distances then is available under the USB specification.

### RELATED PATENT APPLICATION

This application claims priority to commonly owned United States Provisional Patent Application Serial Number 60/574,560; filed May 26, 2004; entitled “USB Transceiver Selection for Integrated Transceiver or Digital Interface First Device To USB Transceiver Second Device,” by Joseph Julicher, Igor Wojewoda and Mei-Ling Chen; which is hereby incorporated by reference herein for all purposes.

### TECHNICAL FIELD OF THE INVENTION

The present invention relates generally to digital serial interfaces, and more particularly, to universal serial bus (USB) interfaces wherein a digital serial interface is adapted for selecting between internal and external USB transceivers, and, additionally, the external USB transceiver may be electrically isolated from the digital serial interface and/or at some distance therebetween.

### BACKGROUND OF THE RELATED TECHNOLOGY

Digital devices may require galvanic (electric) isolation when coupling to a USB device. Isolation over a USB connection between a host device and a peripheral presently is complex and costly. An existing isolation technique is to use two microprocessor controllers. One microprocessor supports an application while the second microprocessor provides the USB interface and the host control. This solution is complex, costly and consumes additional power. It is also desired to communicate over longer distances than is available with a USB bus but still maintain the USB interface.

Therefore, there is a need for more flexibility, simplification, lower cost and power consumption when integrating USB communications between digital devices that may also require electrical isolation therebetween, and/or over longer distances.

### SUMMARY OF THE INVENTION

The present invention overcomes the above-identified problems as well as other shortcomings and deficiencies of existing technologies by providing an apparatus, system and method for coupling an external USB transceiver to a USB interface module or use an internal USB transceiver with the USB interface module of a digital device. The digital device may have a digital processor comprising a microprocessor, microcontroller, digital signal processor (DSP), application specific integrated circuit (ASIC), programmable logic array (PLA), and the like. The external USB transceiver may be easily electrically isolated from the serial interface. Galvanic (electric) isolation may be provided through optical isolation, transformer coupling, etc. The external USB transceiver may additionally be coupled to the USB interface module with a longer distance communications system then is specified under the USB standard. For example, fiber optics, radio signals, infrared, transformer coupling, etc., may be utilized to convey the serial digital signals between the external USB transceiver and the USB interface module. This longer distance communications system may also provide isolate between the external USB transceiver and the USB interface module. In addition the isolation and/or long distance communications system may have an simple and inexpensive single ended digital interface adapted for coupling to the external USB transceiver and the USB interface module.

When building digital devices it is highly desirable to integrate as much of the interface and communications modules into the digital device. Applications may then be configured with low cost internal modules, e.g., internal USB transceiver coupled to an internal serial interface, when electrical (galvanic) isolation of a USB connection is required, or when greater distances are required then is available under the USB specification an external, easily isolatable USB transceiver may be used. This allows more flexibility and thus a greater number of applications for which the digital device may be used.

Selection of either an internal or external USB transceiver to be used with a USB interface module of a digital device may be controlled by software, e.g., through a USB transceiver configuration bit in a configuration register of the digital device. The section of which USB transceiver will be used may also be done with a firmware bit in a non-volatile memory, e.g., flash memory, electrically erasable and programmable memory (EEPROM), fusible links, etc., that may control a data bus selection circuit, e.g., digital multiplexer adapted to connect either the internal or external USB transceiver to the USB interface module of the digital device. The digital device may be fabricated on an semiconductor integrated circuit die and this semiconductor integrated circuit die may be packaged in any type of integrated circuit package. It is contemplated and within the scope of the present invention that the semiconductor integrated circuit die may also be comprised of a plurality of semiconductor integrated circuit dice and may be packaged in a multiple die integrated circuit package.

A technical advantage of the invention is requiring only one USB interface module of a digital device for interfacing with either an internal or external USB transceiver.

Another technical advantage is lower cost to build and develop a digital device since more flexibility in USB interfacing is available without requiring extensive addition digital circuit functions.

Still another technical advantage is the ability to support industrial applications requiring electrical isolation with a low cost solution in a digital device.

A further technical advantage is the ability to have an operational external USB interface at longer distances from a digital device then is presently available at low cost.

Yet another technical advantage is selection of either an internal or external USB transceiver by setting or resetting a bit in a USB transceiver configuration register of a digital device.

Another technical advantage is selection of either an internal or external USB transceiver by setting or resetting a bit in a non-volatile memory of a digital device.

Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is schematic block diagram of a digital system having a digital device with USB interface module adapted for selecting between an internal and external USB interface, according to a specific exemplary embodiment of the present invention; and

FIG. 2 is a schematic block diagram of a typical USB transceiver used with the digital device of FIG. 1.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

Referring now to the drawings, the details of exemplary embodiments of the present invention are schematically illustrated. Like elements in the drawings will be represented by like numbers, and similar elements will be represented by like numbers with a different lower case letter suffix.

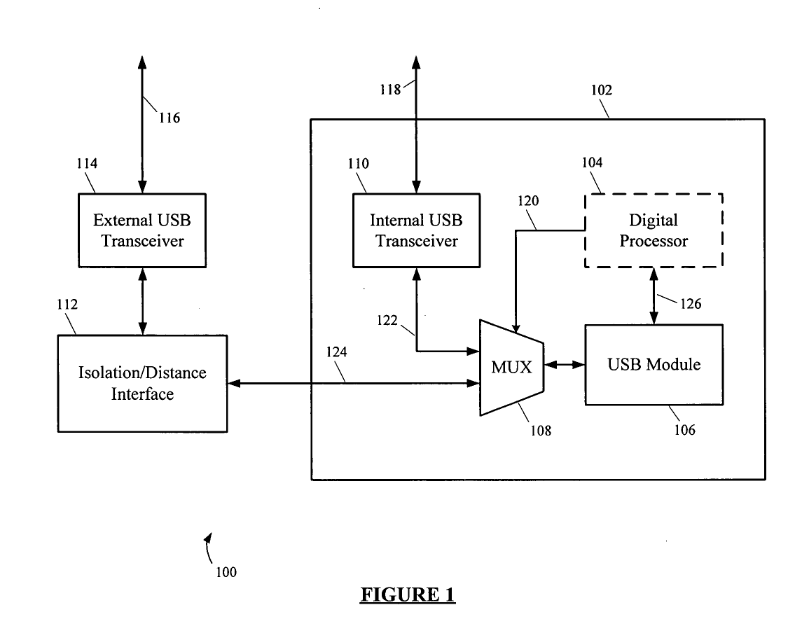

Referring to FIG. 1, depicted is a schematic block diagram of a digital system having a digital device with USB interface module adapted for selecting between an internal and external USB interface, according to a specific exemplary embodiment of the present invention. The digital system is generally represented by the numeral 100, and may comprise a digital device 102, an external USB transceiver 114, and, optionally, an isolation/distance interface 112. The digital device 102 comprises a USB interface module 106, a multiplexer 108, an internal USB transceiver 110, and, optionally, a digital processor 104. The digital processor 104 may be coupled to the USB interface module 106 and may be used to control the multiplexer 108. The digital processor 104 may be comprised of a microprocessor, microcontroller, digital signal processor (DSP), application specific integrated circuit (ASIC), programmable logic array (PLA), and the like.

The USB interface module 106 is coupled to multiplexer 108, wherein the multiplexer 108 is coupled to the internal USB transceiver 110 and is adapted to be coupled to the external USB transceiver 114. Optionally, the multiplexer 108 may be coupled to the external USB transceiver 114 through an isolation and/or distance interface 112. The interface 112 allows electrical isolation and/or increased distance between the external USB transceiver 114 and the digital device 102. The digital device 104 may control the multiplexer 108 over control line 120 for selecting between the internal USB transceiver 110 and the external USB transceiver 114 (optionally coupled through the interface 112). The control line 120 may be operative from a bit logic level in a register (not shown) or may be coupled to a firmware bit in a non-volatile memory (not shown), e.g., flash memory, electrically erasable and programmable memory (EEPROM), fusible links, etc.

The internal USB transceiver 110 is coupled to an input of the multiplexer 108 over an internal bus 122. The USB module 106 is coupled to the digital device 104 through a data bus 126 wherein the USB module 106 generates the appropriate timing, data and control signals in accordance with the USB specification. The internal USB transceiver 110 may be coupled to a USB port 118 and the external USB transceiver 114 may be coupled to a USB port 116. USB ports 116 and 118 may be the same or different USB ports. An input of the multiplexer 108 is adapted for coupling to the external USB transceiver over a simple digital bus 124, e.g., a bus having single ended logic levels. Since the interface 112 may be closely coupled to the digital device 102 through the bus 124, it does not need to be a low noise, low crosstalk differential bus like the USB specification requires of the USB ports 116 and 118.

The digital device 102 may be fabricated on an semiconductor integrated circuit die and this semiconductor integrated circuit die may be packaged in any type of integrated circuit package. It is contemplated and within the scope of the present invention that the semiconductor integrated circuit die may also be comprised of a plurality of semiconductor integrated circuit dice and may be packaged in a multiple die integrated circuit package.

The present invention provides support for both an internal (e.g., on-chip) USB transceiver 110 and an external (e.g., off-chip) USB transceiver 114. The external USB transceiver 114 may be used for applications where physical conditions dictate the location of the USB transceiver 114 to be located away from the digital device 102, and/or the USB transceiver 114 must be electrically (galvanic) isolated from the digital device 102. Electrical isolation of the external USB transceiver 114 may be achieved through well know techniques, e.g., opto-isolators, infrared, radio frequency, transformer coupling, etc.

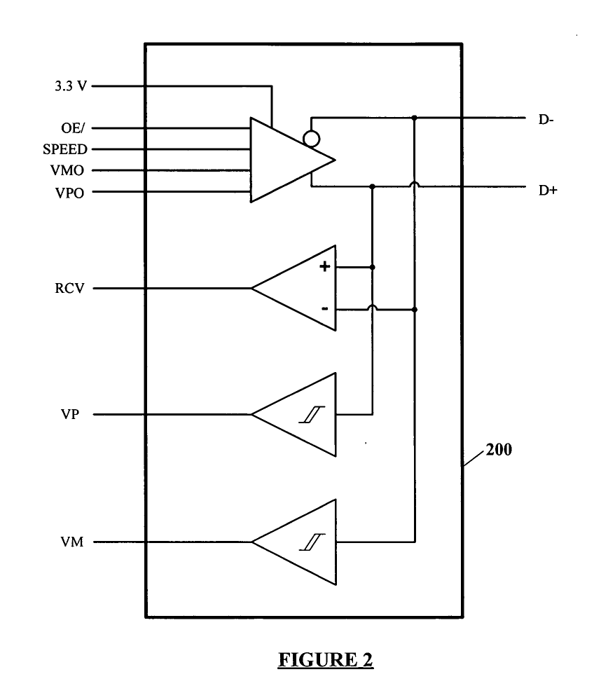

Referring to FIG. 2, depicted is a schematic block diagram of a typical USB transceiver. The typical USB transceiver, generally represented by the numeral 200, comprises an output enable (/OE), slew rate control setting (SPEED), outputs to differential line driver (VMO and VPO), input from differential receiver (RCV), single ended state input of the D+ line (VP), and single ended state input of the D− line (VM). Most of these signals may be coupled directly to the multiplexer 108 (see FIG. 1). However, some of these signals, i.e., SPEED is system dependent and may be hard wired or signaled through a user selected I/O configuration. A stand-alone external USB transceiver 114 may be, for example, a Phillips Universal Serial Bus Transceiver PDIUSBP11A. The Phillips USB transceiver is well know to those of ordinary skill in digital USB interfaces.

The present invention has been described in terms of specific exemplary embodiments. In accordance with the present invention, the parameters for a device may be varied, typically with a design engineer specifying and selecting them for the desired application. Further, it is contemplated that other embodiments, which may be devised readily by persons of ordinary skill in the art based on the teachings set forth herein, may be within the scope of the invention, which is defined by the appended claims. The present invention may be modified and practiced in different but equivalent manners that will be apparent to those skilled in the art and having the benefit of the teachings set forth herein.

1. A digital device adapted for selecting between an internal universal serial bus (USB) transceiver and an external USB transceiver, comprising:
a universal serial bus (USB) module;
an internal USB transceiver;
a multiplexer having an output coupled to the USB module, a first input coupled to the internal USB transceiver, a second input adapted for coupling to an external USB transceiver, and a control input for determining selection of either the internal USB transceiver or the external USB transceiver.

2. The digital device according to claim 1, wherein the second input is adapted for coupling to an isolation interface that isolates the second input from the external USB transceiver.

3. The digital device according to claim 2, wherein the isolation interface comprises a fiber optic isolation interface.

4. The digital device according to claim 2, wherein the isolation interface comprises a radio frequency isolation interface.

5. The digital device according to claim 2, wherein the isolation interface comprises an infrared isolation interface.

6. The digital device according to claim 2, wherein the isolation interface comprises a transformer coupled isolation interface.

7. The digital device according to claim 1, wherein the second input is adapted for coupling to an interface that allows increased distance of operation between the second input and the external USB transceiver.

8. The digital device according to claim 1, further comprising a digital processor coupled to the USB module.

9. The digital device according to claim 8, wherein the digital processor is coupled to the control input of the multiplexer and controls selection of either the internal USB transceiver or the external USB transceiver.

10. The digital device according to claim 8, wherein the digital processor is selected from the group consisting of a microprocessor, microcontroller, digital signal processor (DSP), application specific integrated circuit (ASIC), and programmable logic array (PLA).

11. The digital device according to claim 1, wherein the USB module, the internal USB transceiver and the multiplexer are fabricated on an integrated circuit die.

12. The digital device according to claim 11, wherein the integrated circuit die is enclosed in an integrated circuit package.

13. The digital device according to claim 11, wherein a digital processor is fabricated on the integrated circuit die.

14. The digital device according to claim 1, wherein the control input of the multiplexer is coupled to a non-volatile memory.

15. The digital device according to claim 14, wherein the non-volatile memory is selected from the group consisting of flash memory, electrically erasable and programmable memory (EEPROM) and fusible link.

16. A digital system having a digital device adapted for selecting between an internal universal serial bus (USB) transceiver and an external USB transceiver, said digital system comprising:
a digital device; and
an external universal serial bus (USB) transceiver;
wherein the digital device comprises:
a USB module;
an internal USB transceiver; and
a multiplexer having an output coupled to the USB module, a first input coupled to the internal USB transceiver, a second input coupled to the external USB transceiver, and a control input for determining selection of either the internal USB transceiver or the external USB transceiver.

17. The system according to claim 16, further comprising an isolation interface coupled between the second input of the multiplexer and the external USB transceiver.

18. The device according to claim 17, wherein the isolation interface is selected from the group consisting of a fiber optic isolation interface, a radio frequency isolation interface, an infrared isolation interface, and a transformer coupled isolation interface.

19. The system according to claim 16, further comprising a distance interface coupled between the second input of the multiplexer and the external USB transceiver, wherein the distance interface allows increased distance of operation between the digital device and the external USB transceiver.

20. The system according to claim 16, further comprising a digital processor coupled to the USB module.

21. The system according to claim 16, wherein the digital processor is coupled to the control input of the multiplexer and controls selection of either the internal USB transceiver or the external USB transceiver.

22. The system according to claim 16, wherein the digital processor is selected from the group consisting of a microprocessor, microcontroller, digital signal processor (DSP), application specific integrated circuit (ASIC) and programmable logic array (PLA).

23. The system according to claim 16, wherein the digital device is fabricated on an integrated circuit die.

24. The system according to claim 23, wherein the integrated circuit die is enclosed in an integrated circuit package.

25. The system according to claim 24, wherein a digital processor is fabricated on the integrated circuit die.

26. The system according to claim 16, wherein the control input of the multiplexer is coupled to a non-volatile memory.

27. The system according to claim 26, wherein the non-volatile memory is selected from the group consisting of flash memory, electrically erasable and programmable memory (EEPROM) and fusible link.

28. A method in a digital device for selecting between an internal universal serial bus (USB) transceiver and an external USB transceiver, said method comprising the steps of:
coupling an input of a universal serial bus (USB) module to an internal USB transceiver when a control bit is at a first logic level; and
coupling the input of the universal serial bus (USB) module to an external USB transceiver when the control bit is at a second logic level.

29. The method according to claim 28, wherein the steps of coupling the input of the USB module is done with a multiplexer.

30. The method according to claim 28, further comprising the step of isolating the USB module from the external USB transceiver with an isolation interface.

31. The method according to claim 28, further comprising the step of increasing operating distance between the USB module and the external USB transceiver with a distance interface.

32. The method according to claim 29, further comprising the step of controlling the multiplexer with a digital processor, wherein the digital processor is also coupled to the USB module.

33. The method according to claim 28, wherein the control bit is from a non-volatile memory.
